(19) United States
(12) Patent Application Publication
(10) Pub. No.: US 2026/0138188 A1
(43) Pub. Date: May 21, 2026

(54) ADDITIVE MANUFACTURING SYSTEM EQUIPPED WITH BOTH POWDER AND WIRE CAPABILITIES FOR METAL 3D PRINTING

(71) Applicant: LIASON ENGINEERS PRIVATE LIMITED, Tamil Nadu (IN)

(72) Inventors: Nelson VETHAMONICKAM, Tamil Nadu (IN); Jitender CHAURASIA, Tamil Nadu (IN); Sameer WARGHANE, Tamil Nadu (IN); Karen NELSON, Tamil Nadu (IN)

(73) Assignee: LIASON ENGINEERS PRIVATE LIMITED, Tamil Nadu (IN)

(21) Appl. No.: 19/385,692

(22) Filed: Nov. 11, 2025

(30) Foreign Application Priority Data
Nov. 19, 2024 (IN) 202441089502

(51) Int. Cl. B22F 12/55; B22F 10/22; B22F 10/28; B22F 10/36; B22F 10/85; B22F 12/41; B33Y 30/00; B33Y 50/02

(52) U.S. Cl. CPC B22F 12/55; B22F 10/22; B22F 10/28; B22F 10/36; B22F 10/85; B22F 12/41; B33Y 30/00; B33Y 50/02

(57) ABSTRACT

The present invention discloses an additive manufacturing system (1) with powder and wire capabilities for metal 3D printing comprises a dual-head configuration assembly (2). This assembly includes a wire deposition head (3) and a powder deposition head (4), both mounted on a common axis to move together. The wire deposition head (3) deposits material in wire feedstock form, while the powder deposition head (4) deposits material in powder feedstock form. A carriage (6) connects to both heads, enabling movement along a hollow rectangular channel, allowing lateral movement. Vertical rails (7) facilitate independent vertical travel of each head to avoid obstructions during deposition. A laser source assembly (8) is connected to both heads, generating an input laser beam to move and automatically switch between the wire and powder deposition heads for printing in respective feedstock forms. This configuration enhances flexibility and efficiency in metal 3D printing processes.

### FIELD OF INVENTION

The proposed invention relates to an additive manufacturing system. More particularly, the invention relates to the additive manufacturing system equipped with both powder and wire capabilities for metal 3D printing.

### BACKGROUND

Additive Manufacturing (AM), commonly known as 3D printing, has emerged as a transformative technology in the manufacturing sector, offering the ability to create complex geometries with high precision through a layer-by-layer material addition process. Unlike traditional subtractive manufacturing methods, which involve removing material from a solid block, AM builds objects by progressively adding material based on digital models, such as Computer Aided Design (CAD) files. The field encompasses a variety of processes, as defined by the international standard ISO/ASTM 52900, which categorizes AM into seven distinct classes: Material Extrusion, Powder Bed Fusion, Vat Photopolymerization, Material Jetting, Binder Jetting, Sheet Lamination, and Directed Energy Deposition (DED).

Among these, Laser Directed Energy Deposition (Laser DED) has gained prominence, particularly in Metal Additive Manufacturing. Laser DED systems offer the capability to use either wire or powder as feedstock, each with distinct advantages and limitations. Wire feedstock is known for its high deposition rates and material capture efficiency but often results in a coarser surface finish and larger feature sizes. Conversely, powder feedstock offers finer precision, better surface finish, and the ability to mix powders for creating composite or functionally graded materials (FGMs). However, powder feedstock presents challenges such as lower deposition rates, poor catchment efficiency, and potential respiratory health hazards due to airborne particles.

The evolution of AM from its initial role as a rapid prototyping tool to a full-fledged manufacturing technique has been significant, with increasing adoption across industries such as aerospace, medical, defense, and more. This shift has been driven by the demand for high-performance materials and complex geometries that traditional manufacturing methods cannot easily produce. However, the transition to Metal AM, and specifically Laser DED, has highlighted several challenges that impede its widespread industrial adoption.

One of the primary challenges in Metal AM is the economic viability and versatility of the processes. Powder Bed Fusion (PBF) and DED are the two methods for metal 3D printing. While PBF offers high-resolution printing capabilities, it suffers from limitations such as restricted build volumes, slow deposition rates, and a lack of flexibility in adding features or repairing existing parts. Efforts to overcome these limitations, such as using multiple laser sources or selective powder deposition, have yet to fully address the challenges or prove economically viable.

The Laser DED offers a versatile alternative with the ability to deposit multiple materials, create large-scale parts, and perform operations more efficiently. However, the current market scenario predominantly features Laser DED systems that utilize a single feedstock type—either powder or wire. This limitation creates a gap in the ability to achieve both high deposition rates and fine feature sizes within the same machine. Existing solutions that offer multiple deposition heads require manual or robotic intervention for changing the heads, leading to significant time and cost inefficiencies, as well as the need for a highly skilled workforce.

Addressing these disadvantages or providing a viable alternative is crucial for the successful industrial adoption of the Laser DED technology. There is a need for innovative solutions that can seamlessly integrate the benefits of both wire and powder feedstocks without compromising on efficiency, precision, or economic feasibility.

### OBJECT OF INVENTION

The primary object of the embodiments herein is an additive manufacturing system equipped with both powder and wire capabilities for metal 3D printing.

Another object of the embodiments herein is to provide a dual-head configuration assembly that allows for simultaneous or sequential deposition of powder and wire, offering flexibility in creating complex parts with varied material properties.

Yet another object of the embodiments herein is to provide production of custom parts with specific attributes (e.g., fine details or robust features) by switching between or combining deposition methods.

Yet another objective is to rapidly switch between high-resolution powder deposition and high-speed wire deposition, which helps in speeding up the manufacturing process.

Yet another object of the embodiments herein is to combine both deposition methods in a single system, reducing the need for separate setups and adjustments, thereby lowering production downtime.

### SUMMARY

The present invention relates to an additive manufacturing system equipped with both powder and wire capabilities for metal 3D printing. This system includes a dual-head configuration assembly, which includes a wire deposition head and a powder deposition head. The wire deposition head is designed to deposit material at a workspace in a wire feedstock form, while the powder deposition head deposits material in a powder feedstock form. Both heads are mounted on a common axis, allowing them to move together. A carriage is connected to both the wire deposition head and the powder deposition head. This carriage is configured to move along a hollow rectangular channel, enabling the movement of both heads from left to right or vice versa. Vertical rails are provided for each deposition head, allowing them to travel independently in up and down directions. This independent movement helps avoid obstructions during the deposition process. Further, a laser source assembly is connected to both the wire deposition head and the powder deposition head. This assembly generates an input laser beam, which facilitates the movement of one of the deposition heads. It also enables automatic switching between the wire deposition head and the powder deposition head, allowing for the printing of deposited material in both wire and powder feedstock forms.

In an embodiment, the wire deposition head and the powder deposition head independently move in a vertically upward direction and a vertically downward direction to avoid obstruction of a tool path when the wire deposition head is activated.

In an embodiment, the laser source assembly includes a laser generator designed to produce the input laser beam. A first optical fiber connect the laser generator to the wire deposition head, while a second optical fiber links the laser generator to the powder deposition head. The first optical fiber is used for deposition of the material in the wire feedstock form and the second optical fiber is used for deposition of the material in the powder feedstock form based on the input laser beam received from the laser generator. The assembly features a beam switch connected to the laser generator, which is electrically controlled and capable of receiving the input laser beam and distributing it into four output beams. A programmable logic controller (PLC) is operatively connected to the beam switch, located within an electrical cabinet, and configured to control the operation of the beam switch. Additionally, an operator interface is configured to send control signals to the PLC, with these control signals including M-Code instructions for selecting one of the four output beams.

In an embodiment, the beam switch is responsive to the control signals from the PLC to selectively direct the input laser beam to the first optical fiber and the second optical fiber.

In an embodiment, the control signals are provided based on at least one of a deposition rate of the material that is melted and deposited onto a substrate per unit of time, a feature size and an available feedstock.

In an embodiment, switching of the input laser beam is programmable for redirecting the input laser beam between the first optical fiber and the second optical fiber in a predefined time period.

In an embodiment, the hollow rectangular channel is equipped with linear guiding rails and driving motors on both front and back sides, allowing traversal of the heads around the workspace.

In an embodiment, the wire deposition head is mounted on a front side of the additive manufacturing system while the powder deposition head is mounted on a back side of the additive manufacturing system for ease of an operator to change wire or cut the wire without any hassle while an argon chamber is closed.

In an embodiment, the powder deposition head is configured to rotate independently to accommodate complex geometries or surfaces that are not perpendicular to the powder deposition head.

In an embodiment, the argon chamber surrounds the wire deposition head and the powder deposition head, maintaining an inert atmosphere to prevent oxidation of reactive materials during a printing process.

In an embodiment, the additive manufacturing system includes limit switches integrated with the carriage to prevent the powder deposition head and the wire deposition head from exceeding safe operational limits.

In an embodiment, the additive manufacturing system includes a wire straightener positioned on a left side of the wire deposition head for wire feed from a spool.

In an embodiment, the additive manufacturing system includes two, 2-color pyrometers one connected to the wire deposition head and the powder deposition head, wherein the 2-color pyrometers captures time-temperature data to control melt pool temperature by adjusting the input laser beam, and wherein the 2-color pyrometers is capable of independent rotation for cladding on vertical or tilted surfaces to maintain perpendicularity to a deposition surface.

In an embodiment, the additive manufacturing system includes servo drives for positioning the wire deposition head and the powder deposition head at a known or desired position.

In an embodiment, the additive manufacturing system includes rails connected to the vertical rails to allows the wire deposition head and the powder deposition head to travel front and back direction.

In an embodiment, the additive manufacturing system includes pneumatic system to take the wire deposition head and the powder deposition head up and down direction.

In an embodiment, the additive manufacturing system includes guide rails connected to the powder deposition head for independent movement of the powder deposition head.

In an embodiment, the additive manufacturing system includes water cooling line split connected to the powder deposition head to manage the thermal conditions of the powder deposition head during an additive manufacturing process.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

The proposed invention is illustrated in the accompanying drawings, throughout which like reference letters indicate corresponding parts in the various figures. The embodiments herein will be better understood from the following description with reference to the drawings in which:

FIG. 1 is a schematic diagram that illustrates an additive manufacturing system having a dual-head configuration assembly with two deposition heads mounted on the same axis and their degree of freedom according to embodiments as disclosed herein.

FIGS. 2a-2d illustrate various views of two deposition heads configured on the additive manufacturing system according to embodiments as disclosed herein.

FIGS. 3a-3d illustrate various views of the additive manufacturing system equipped with both powder and wire capabilities for metal 3D printing according to embodiments as disclosed herein.

FIG. 4 illustrates a block diagram of the laser source assembly, according to embodiments as disclosed herein.

FIG. 5a is a schematic diagram that illustrates the two deposition heads placed inside a tool bay where a manual changeover is needed according to prior art.

FIG. 5b is a schematic diagram that illustrates the two deposition heads placed inside a tool bay where both the two deposition heads are uniaxially mounted without changeover requirement according to embodiments as disclosed herein.

FIG. 6a is a schematic diagram that illustrates a single laser fiber used to connect multiple deposition heads according to prior art.

FIG. 6b is a schematic diagram that illustrates the two deposition heads mounted on the same axis and independent laser fibers are ready to use without any changeover time according to embodiments as disclosed herein.

It may be noted that, to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help improve the understanding of aspects of the proposed invention. Furthermore, the one or more elements may have been represented in the drawing by conventional symbols, and the drawings may show only those specific details that are pertinent to the understanding of the embodiments of the proposed invention so as not to obscure the drawing with details that will be readily apparent to those of ordinary skill in the art having the benefit of the description herein.

### DETAILED DESCRIPTION OF INVENTION

The implementations herein and the various features and advantageous details thereof are explained more fully with reference to the non-limiting implementations that are illustrated in the accompanying drawings and detailed in the following description. It should be understood, however, that the following descriptions, while indicating preferred implementations and numerous specific details thereof, are given by way of illustration and not of limitation. Many changes and modifications may be made within the scope of the implementations herein, and the implementations herein include all such modifications. The examples used herein are intended merely to facilitate an understanding of ways in which the implementations herein can be practiced and to further enable those skilled in the art to practice the implementations herein. Accordingly, the examples should not be construed as limiting the scope of the implementations herein.

Descriptions of well-known components and processing techniques are omitted so as to not unnecessarily obscure the implementations herein. Also, the various implementations described herein are not necessarily mutually exclusive, as some implementations can be combined with one or more other implementations to form new implementations.

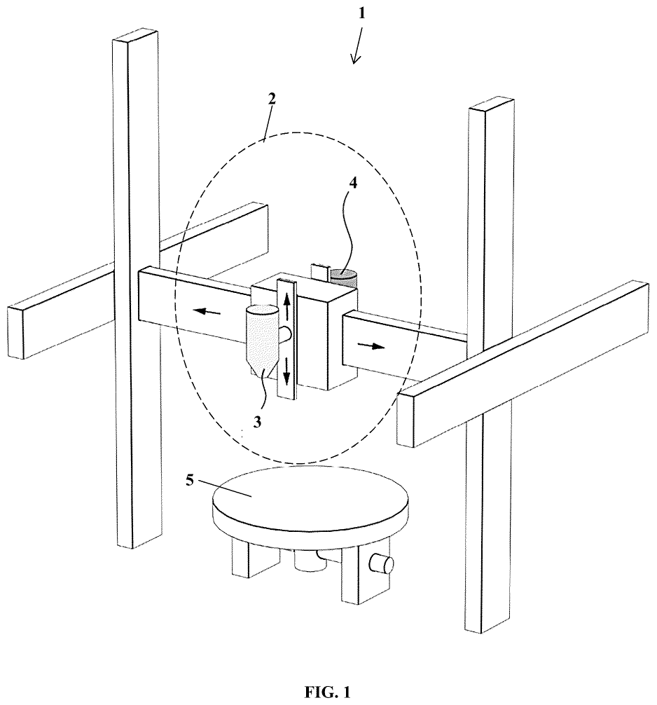

Referring now to the drawings, and more particularly to FIGS. 1 through 6b, where similar reference characters denote corresponding features consistently throughout the figures, there are shown preferred implementations. Further, for the sake of simplicity, and without limitation, the same numbers are used throughout the drawings to reference like features and components. The implementations herein will be better understood from the following description with reference to the drawings.

FIG. 1 is a schematic diagram that illustrates an additive manufacturing system (1) having a dual-head configuration assembly (2) with two deposition heads mounted on the same axis and their degree of freedom, according to embodiments as disclosed herein. The proposed invention provides the dual-head configuration assembly (2) that includes a wire deposition head (3) to deposit the material at a workspace (5) in a wire feedstock form and a powder deposition head (4) to deposit the material in a powder feedstock form. The wire deposition head (3) and the powder deposition head (4) are mounted on a common axis and move together. The wire deposition head (3) and the powder deposition head (4) independently move in a vertically upward direction and a vertically downward direction to avoid obstruction of a tool path when the wire deposition head (3) or power deposition head (4) is activated. As illustrated in the FIG. 1, the wire deposition head (3) is mounted on a front side of the additive manufacturing system (1) while the powder deposition head (4) is mounted on a back side of the additive manufacturing system (1) for ease of an operator to change wire or cut the wire without any hassle while an argon chamber is closed. The powder deposition head (4) is configured to rotate independently to accommodate complex geometries or surfaces that are not perpendicular to the powder deposition head (4).

The additive manufacturing system (1) described herein is designed to enhance flexibility and efficiency in the production of complex parts by utilizing a dual-head configuration assembly (2). This innovative setup allows for the sequencial or alternate use of both wire and powder feedstock forms, providing manufacturers with the ability to choose the most suitable material deposition method for their specific application. The wire deposition head (3) is particularly advantageous for applications requiring continuous material deposition, such as the creation of large, solid structures. In contrast, the powder deposition head (4) offers precision and versatility, making it ideal for intricate details and complex geometries. By integrating both heads on a common axis, the system ensures seamless transitions between different deposition methods, thereby optimizing the manufacturing process and reducing downtime.

The dual-head configuration assembly (2) is engineered to maximize operational efficiency while minimizing the potential for interference during the manufacturing process. The independent vertical movement of the wire deposition head (3) and the powder deposition head (4) ensures that each head can be activated or deactivated without obstructing the tool path of the other. This design feature is particularly beneficial in scenarios where rapid switching between wire and powder deposition is required, allowing for uninterrupted production and enhanced precision. Furthermore, the strategic placement of the wire deposition head (3) on the front side of the system facilitates easy access for operators to change or cut the wire, even when the argon chamber is closed, thereby maintaining a controlled environment and preventing contamination.

Additionally, the powder deposition head (4) is equipped with the capability to rotate independently, which significantly expands the system's ability to accommodate complex geometries and surfaces that are not perpendicular to the head. This rotational feature is used for manufacturing parts with intricate designs, as it allows the deposition head to adjust its orientation to maintain optimal deposition angles, ensuring consistent material application and structural integrity. The adaptability of the powder deposition head (4) enhances the system's overall versatility, making it suitable for a wide range of applications across various industries, from aerospace to automotive, where precision and adaptability are paramount. This dual-head configuration not only improves the quality and complexity of the manufactured parts but also streamlines the production process, offering a competitive edge in the rapidly evolving field of additive manufacturing.

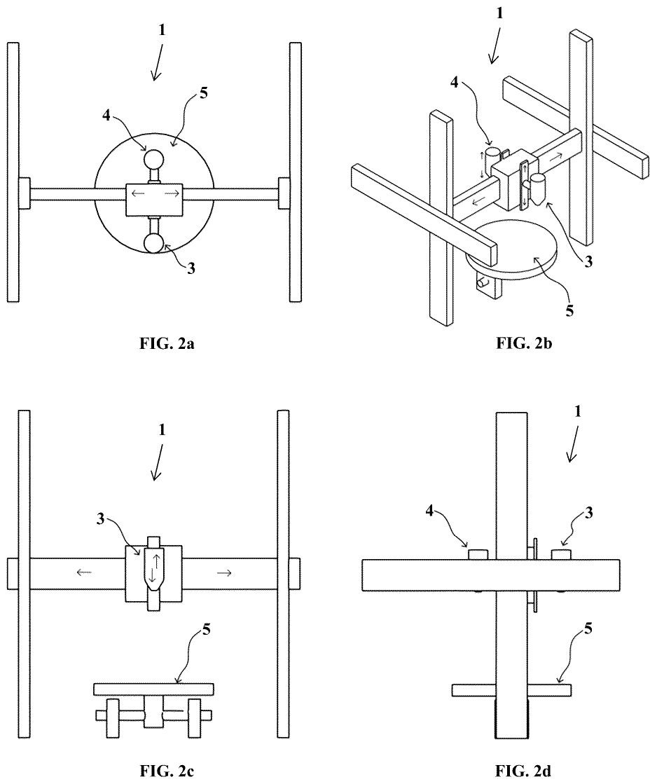

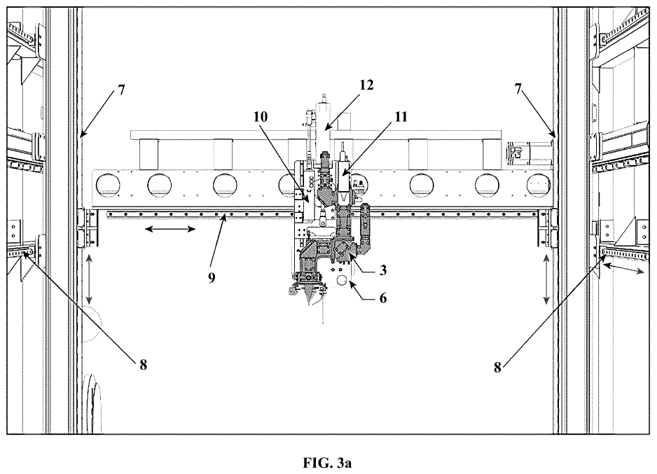

FIGS. 2a-2d illustrate various views of two deposition heads namely, the wire deposition head (3) and the powder deposition head (4) as they are integrated into the additive manufacturing system (1), according to embodiments as disclosed herein. These figures collectively offer a multi-angled perspective, showcasing the strategic placement and potential applications of each deposition head. FIG. 2a offers a top-down view, allowing for an understanding of how the deposition heads are spatially arranged on the system. This perspective is particularly useful for visualizing the overall layout and ensuring that the heads are optimally positioned to maximize the workspace and minimize interference with other components of the system.

Moving to FIG. 2b, the isometric view provides a three-dimensional representation of the wire and powder deposition heads. This view illustrates the depth and spatial relationships between different components, offering insights into how these deposition heads interact with the rest of the system. It highlights the design considerations that allow these heads to function cohesively, despite being mounted on the same axis. The ability to visualize the heads from this angle aids in understanding the ergonomic and mechanical design choices that facilitate smooth operation and transition between different deposition modes.

The subsequent illustrations, FIG. 2c and FIG. 2d, present the front and side views, respectively, of the deposition heads. These views illustrates the vertical movement capabilities of the heads. The ability of each head to move independently up and down enhances the system's flexibility. This independent movement ensures that when one deposition head is active, the other can be retracted to avoid obstruction, thereby maintaining an unobstructed tool path. This feature is particularly beneficial when dealing with complex geometries or when switching between different materials and deposition rates. The adaptability offered by these independent movements allows the system to cater to a wide range of manufacturing requirements, from varying deposition rates to different feature sizes and feedstock types.

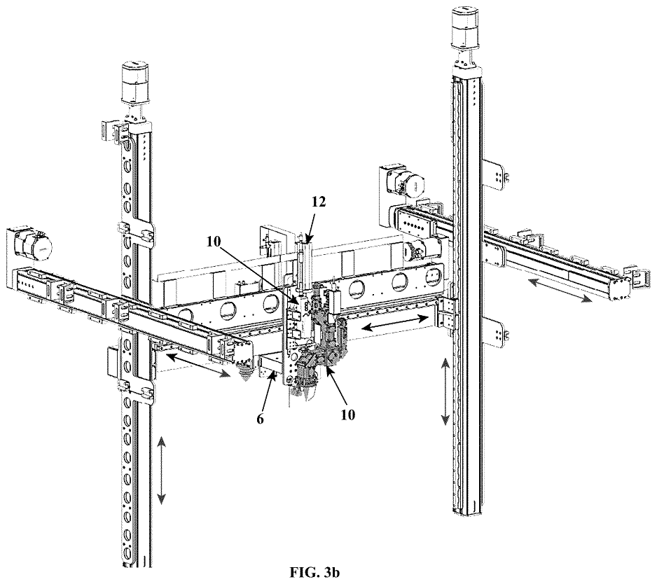

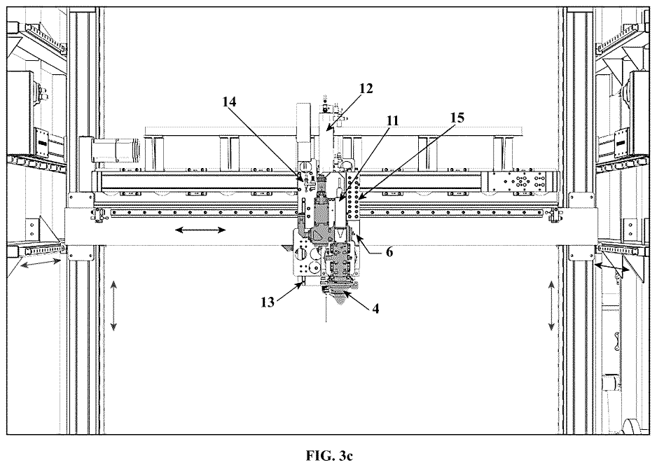

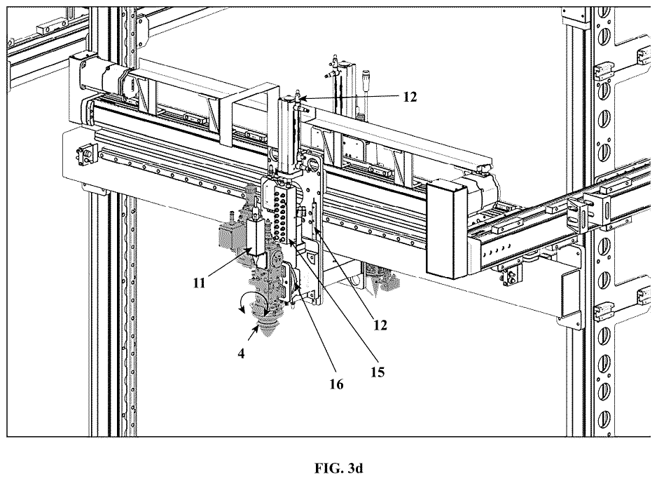

FIGS. 3a-3d illustrate various views of the additive manufacturing system (1) equipped with both powder and wire capabilities for metal 3D printing according to embodiments as disclosed herein. FIGS. 3a-3b illustrate front and isometric front views, respectively, of the additive manufacturing system (1), while FIGS. 3c-3d illustrate back and isometric back views, respectively, of the additive manufacturing system (1). The additive manufacturing system (1) includes a dual-head configuration assembly (2), a wire deposition head (3), a powder deposition head (4), a workspace (5), a carriage (6), vertical rails (7), a laser source assembly (8), linear guiding rails (9), a wire straightener (10), two color pyrometers (11), a pneumatic system (12), guide rails (13), limit switches (14), and a water cooling line split (15).

The dual-head configuration assembly (2) includes a wire deposition head (3) to deposit the material at the workspace (5) in a wire feedstock form and a powder deposition head (4) to deposit the material in a powder feedstock form. The wire deposition head (3) is equipped with a precision nozzle that ensures consistent wire feed and deposition, while the powder deposition head (4) utilizes a high-efficiency powder delivery system to ensure uniform distribution of powder particles. Both heads are designed to handle a variety of materials, including metals, polymers, and composites, allowing for versatile applications in additive manufacturing. The integration of these two deposition methods in a single assembly enables the creation of complex geometries and multi-material components with enhanced mechanical properties.

The wire deposition head (3) and the powder deposition head (4) are mounted on a common axis and move together. The common axis design minimizes the footprint of the assembly, making it suitable for integration into compact manufacturing environments. The wire deposition head (3) and the powder deposition head (4) independently move in a vertically upward direction and a vertically downward direction to avoid obstruction of a tool path when the wire deposition head (3) is activated. This independent movement is facilitated by a dual-motor system, each motor dedicated to one of the deposition heads, providing rapid and precise vertical adjustments.

As described before, both the wire deposition head (3) and the powder deposition head (4) can move independently in the vertical direction. Adding this degree of freedom adds the following capabilities: the wire deposition head (3) and the powder deposition head (4) can move vertically independently so they don't obstruct each other's path, avoiding the possibility of collision with the 3D printed part. This independent movement maintains the integrity of the printed structure, especially when dealing with overhangs or complex internal features. The system is equipped with sensors that detect the proximity of the heads to the printed part, providing real-time feedback to the control system to prevent accidental contact.

Usually, the wire deposition head (3) and the powder deposition head (4) have a fixed working offset, which means the distance between the wire deposition head (3) and the powder deposition head (4) tip and the substrate or the previously deposited layer remains constant. However, in most cases, it is difficult to maintain this distance due to the possibility of under & over deposition.

The wire deposition head (3) and powder deposition head (4) are key components of the advanced additive manufacturing system (1), each strategically placed for optimal functionality and ease of use. The wire deposition head (3) is positioned at the front, allowing easy access for wire changes or cuts, minimizing downtime, and maintaining efficiency, especially when the argon chamber is sealed.

Further, the powder deposition head (4) is located at the back and can rotate independently, which is beneficial for handling complex geometries or non-perpendicular surfaces. This rotation ensures material deposition across various angles. This adaptability broadens the scope of additive manufacturing, allowing for highly customized and complex components.

The entire system operates within the argon chamber, maintaining an inert atmosphere for preventing oxidation, especially with reactive materials like titanium. The argon chamber surrounds the wire deposition head (3) and the powder deposition head (4), maintaining an inert atmosphere to prevent oxidation of reactive materials during a printing process. The argon chamber protects the wire deposition head (3) from oxygen exposure, preserving material integrity and enhancing the quality and durability of printed components.

The carriage (6) is used in the operation of the deposition system, serving as the primary mechanism for moving both the wire deposition head (3) and the powder deposition head (4) along a predetermined path. This path is defined by a hollow rectangular channel, which provides a stable and precise track for the carriage's movement. The ability of the carriage to move bidirectionally—from left to right and vice versa—ensures that the deposition process can cover the entire work area efficiently. This design allows for a seamless transition between different sections of the workpiece, enabling continuous and uninterrupted deposition of materials. The synchronized movement of the wire and powder deposition heads with the carriage ensures that both materials can be applied in a coordinated manner.

Further, the independent vertical rails (7) for each deposition head introduce a significant degree of flexibility and precision to the system. These vertical rails allow the wire deposition head (3) and the powder deposition head (4) to move up and down independently of each other. This independent movement avoids any potential obstructions that might occur if both heads were to operate on the same vertical plane. For instance, if a particular section of the workpiece requires only wire deposition, the powder deposition head can be raised out of the way, and vice versa. This capability enhances the efficiency of the deposition process and minimizes the risk of errors or defects in the final product by ensuring that each material is deposited exactly where it is needed.

In addition to the vertical movement, the system is further enhanced by the inclusion of rails (8) that connect to the vertical rails (7). These additional rails allow the deposition heads to travel in the front and back directions, adding yet another layer of versatility to the system. This multi-directional movement capability means that the deposition heads can approach the workpiece from various angles, making it possible to deposit materials on complex geometries and surfaces that would otherwise be difficult to reach. Such a comprehensive range of motion ensures that the deposition system can be used for a wide variety of applications, from simple flat surfaces to intricate three-dimensional structures, thereby expanding the potential use cases for this technology in advanced manufacturing and repair processes.

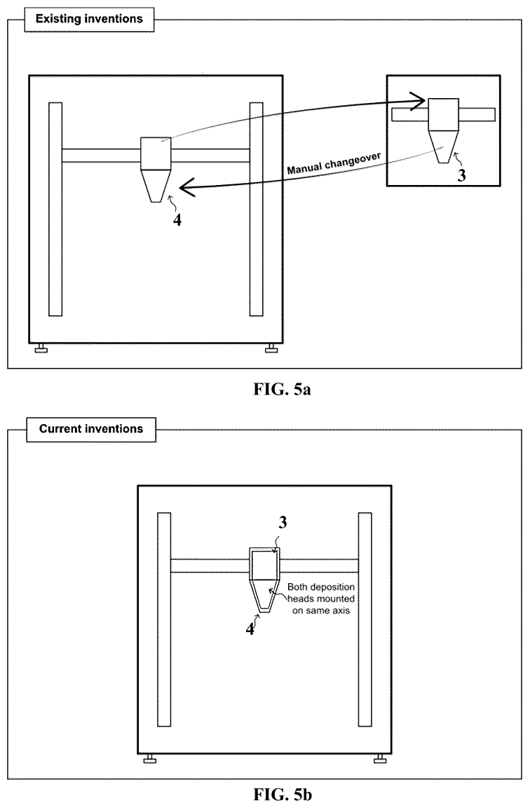

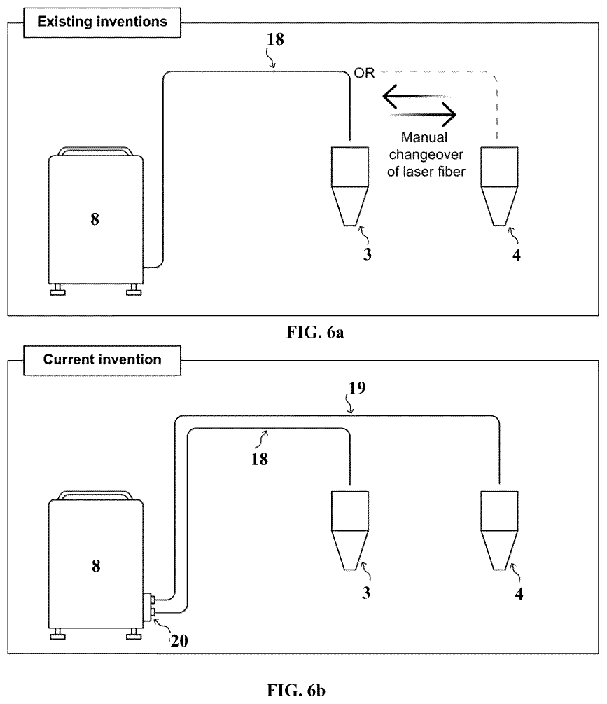

The laser source assembly (8) is connected to the wire deposition head (3) and the powder deposition head (4). The laser source assembly (8) generates an input laser beam to move one of the wire deposition head (3) and the powder deposition head (4) and automatically switch between the wire deposition head (3) and the powder deposition head (4) for printing the deposited material in the wire feedstock form and the powder feedstock form. The details of the laser source assembly (8) are described in conjunction with the FIGS. 5-6.

In an embodiment, the hollow rectangular channel is equipped with linear guiding rails (9) and driving motors on both the front and back sides, allowing for seamless traversal of the heads (3, 4) arounds the workspace (5). This configuration ensures that the system can efficiently navigate the designated area, providing precise control over the deposition process. The linear guiding rails (9) facilitate smooth and accurate movement, minimizing any potential disruptions or deviations during operation. The driving motors are designed to offer robust performance, enabling the system to handle various operational demands effectively. This setup enhances the overall efficiency of the deposition process and contributes to the longevity and reliability of the system by reducing mechanical stress and wear.

In an embodiment, the wire straightener (10) is strategically positioned on the left side of the wire deposition head (3), ensuring a smooth and consistent wire feed from a spool. This placement is used for maintaining the integrity and quality of the wire as it is fed into the deposition head. The wire straightener (10) eliminates any kinks or bends in the wire, which could otherwise compromise the deposition quality. By ensuring a straight and uniform wire feed, the system can achieve a higher level of precision and consistency in the deposition process.

On the right-hand side of the wire deposition head (3), the two color pyrometers (11) are connected to capture time-temperature data, which is used for controlling the melt pool temperature by adjusting the input laser beam. The two color pyrometers (11) are equipped with the capability of independent rotation, allowing it to maintain perpendicularity to a deposition surface, even when cladding on vertical or tilted surfaces. This feature is used for ensuring uniform heat distribution and optimal cladding results. Both the color pyrometers (11) sends a 0 -10 V signal to the laser power unit, where the voltage range indicates the minimum to maximum tunable power limit of the laser device. This precise control mechanism ensures that the laser power is adjusted in real-time based on the temperature data, thereby optimizing the deposition process. Similarly, on the other side of the system (1), the powder deposition head (4) is mounted on a carriage (6) with independent vertical movement. The powder deposition head (4) is also connected with the two color pyrometers (11) to control the melt pool temperature by controlling laser power, similar to the wire deposition head (3). The innovative aspect of the powder deposition head (4) is its ability to rotate independently, as illustrated in FIG. 3d. This independent rotation capability is particularly useful when cladding on vertical or tilted surfaces, as it allows the head to be adjusted to the required angle, ensuring that it remains perpendicular to the surface. This adaptability is used for achieving high-quality deposition on complex geometries, where the surface may be curved, uneven, slanted, or vertical. By allowing the deposition heads to be rotated to the optimal angle, the system can deliver superior performance and precision, regardless of the surface orientation.

In an embodiment, the pneumatic system (12) to take the wire deposition head (3) and the powder deposition head (4) up and down direction. The pneumatic system (12) includes a series of air cylinders and valves that are controlled to adjust the vertical position of the deposition heads. These air cylinders are connected to a central control unit that modulates the air pressure, allowing for smooth and rapid movement of the wire deposition head (3) and the powder deposition head (4). The system (1) is designed to accommodate varying material deposition rates by adjusting the speed and position of the heads, ensuring optimal layer adhesion and surface finish. Further, sensors are integrated into the pneumatic system (12) to provide real-time feedback on the position of the wire deposition head (3) and the powder deposition head (4), enabling precise control and repeatability in the manufacturing process.

In an embodiment, guide rails (13) are attached to the powder deposition head (4) to enable its independent movement, allowing precise and consistent powder application. This setup optimizes the deposition process by adjusting the head's position and orientations. Independent movement also minimizes interference with other system components, enhancing efficiency and reliability.

In an embodiment, limit switches (14) are integrated with the carriage (6) to prevent the powder deposition head (4) and wire deposition head (3) from exceeding operational limits. These switches act as safety mechanisms, protecting equipment and ensuring operational safety by automatically stopping the heads if they approach set boundaries. This enhances precision by keeping the heads within a controlled range.

Further, servo drives control the powder deposition head (4) and wire deposition head (3), ensuring precise positioning and repeatability. Servo drives enable rapid, accurate adjustments, allowing the heads to return to designated positions with minimal error. This integration improves system performance by providing reliable and efficient deposition control.

In an embodiment, the water cooling line split (15) is connected to the powder deposition head (4) to manage the thermal conditions of the powder deposition head (4) during an additive manufacturing process. The water cooling line split (14) is designed to manage the thermal conditions of the powder deposition head (4) during the additive manufacturing process. This water cooling line split (14) is equipped with a series of channels or pipes that facilitate the rapid dissipation of heat generated during the deposition of powder materials. The channels are strategically positioned to ensure uniform cooling across the entire surface of the deposition head, thereby preventing thermal deformation and ensuring layer quality. Additionally, the cooling line is integrated with a temperature sensor array that monitors the thermal profile of the wire deposition head (3) and the powder deposition head (4), allowing for real-time adjustments to the cooling rate to maintain optimal operating conditions.

In scenarios where an additive manufacturing system operates without an argon inert environment, the process of changing components is straightforward. The operator simply needs to replace the head and optical fibers. However, when an argon inert chamber is utilized, the procedure becomes more complex. Initially, the operator must release the argon, then proceed to change the head and fibers, and subsequently recreate the inert atmosphere. It is important to note that creating an argon environment with an oxygen level of 10-50 ppm requires approximately 110-150 cylinders of argon gas. Additionally, achieving the desired oxygen level can take between 18-24 hours, depending on the cleanliness of the argon chamber.

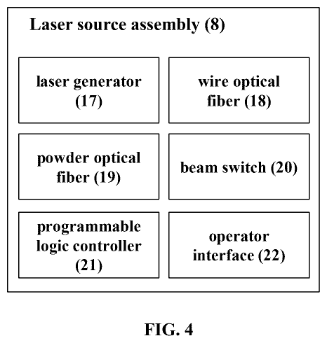

FIG. 4 illustrates a block diagram of the laser source assembly (8), according to embodiments as disclosed herein. The laser source assembly (8) includes a laser generator (17), a first optical fiber (18), a second optical fiber (19), an beam switch (20), a programmable logic controller (PLC) (21), and an operator interface (22).

The laser generator (17) is responsible for producing the input laser beam for the operation of both the wire and powder deposition processes. The first optical fiber (18) serves as a conduit, efficiently transmitting the laser beam from the laser generator (17) to the wire deposition head (3). The first optical fiber (18) is used for deposition of the material in the wire feedstock form based on the input laser beam received from the laser generator (17). This precise delivery ensures that the wire deposition head can perform its task of adding material to a substrate. Similarly, the second optical fiber (19) connects the laser generator (17) to the powder deposition head (4), enabling the system to handle powder-based deposition tasks. The second optical fiber (19) is used for deposition of the material in the powder feedstock form based on the input laser beam received from the laser generator (17). This dual capability allows the system to be versatile, accommodating different materials and deposition techniques depending on the specific requirements of a project.

The beam switch (20) is connected to the laser generator (17), the beam switch (20) is electrically controlled and designed to receive the input laser beam, subsequently distributing it into four distinct output beams. This functionality is used for applications that require multiple deposition heads or processes to be used in tandem or in sequence. The beam switch (20) is operatively connected to the PLC (21), which is housed within an electrical cabinet. The PLC (21) is configured to manage the operation of the beam switch (20), ensuring that the correct output beam is selected and directed to the appropriate deposition head as needed.

An operator interface (22) is provided to facilitate user interaction with the system. This interface is configured to send control signals, including M-Code instructions, to the PLC (21). These M-Code instructions are integral to the system's operation, allowing the user to select one of the four output beams with ease. Notably, the current system employs the same M-Code as used in other machines, promoting familiarity and ease of integration for operators already accustomed to such codes. Unlike existing systems that require multiple adjustments—such as recalibration, tool height adjustment, and resetting the tool offset from the work plane—when a deposition head is changed, the current invention's controller/PLC is designed to remember or store both heads as two separate tools. This capability allows the system to automatically run a sub-routine on the controller, which handles all necessary tasks during a manual changeover, thereby reducing downtime and increasing operational efficiency.

The beam switch (20) functions by responding to control signals from the PLC (21), which directs the laser beam either to the first optical fiber (18) or the second optical fiber (19). This decision-making process is governed by several factors, including the deposition rate, feature size, and available feedstock. The deposition rate, a key performance metric, is particularly significant as it influences the build speed, layer thickness, and overall productivity of the L-DED process. A higher deposition rate typically results in faster builds, which is advantageous for large-scale applications, but it may compromise the resolution or surface quality of the final product. This rate is usually quantified in grams per minute (g/min) or kilograms per hour (kg/h).

In the context of the current invention, which employs dual deposition technology, the system offers a choice between wire and powder deposition heads. The wire deposition head is generally associated with a higher deposition rate, making it suitable for rapid builds where fine detail is not a primary concern. On the other hand, the powder deposition head, with its comparatively lower deposition rate, is better suited for applications requiring fine details and precision. This dual-head system provides users with the flexibility to tailor the deposition process to specific project requirements, enhancing the versatility and adaptability of the L-DED system.

The selection between the wire and powder deposition heads is not governed by a specific logic but is instead left to the discretion of the user, who can make the choice by entering a machine code known as M-Code. This flexibility allows users to adapt the process based on material availability, feature size, and the need for functionally graded materials. For instance, materials may not be suitable for wire drawing, necessitating the use of powder. Additionally, when dealing with smaller feature sizes, typically below 2-3 mm, the powder deposition head becomes the preferred choice. Furthermore, the system's capability to handle functionally graded materials is enhanced by the powder deposition head's dual hopper design, which allows for the mixing of two different materials in any proportion. This feature is used for creating parts with variable capabilities, such as those that require a gradient from one material to another, thereby combining the benefits of both materials in a single component.

In an embodiment, the programmable switching of the input laser beam between the first optical fiber and the second optical fiber enhances the flexibility and efficiency of the system. This programmability allows for precise control over the deposition process, enabling the system to switch seamlessly between different modes of operation within a predefined time period. The use of a PLC system is used in achieving this level of control, as it offers a rapid response time ranging from 10 to 50 microseconds. This swift response ensures that commands to activate either the power or wire deposition head are executed almost instantaneously, within a fraction of a second.

While the electronic components of the system, such as the laser and servo motors, can be activated or deactivated almost instantaneously, the mechanical aspects of the system require more time. The automatic changeover of the deposition heads, which involves mechanical movements, is a more time-consuming process. This changeover includes several steps: the active head must return to its home position, the new head moves vertically down to the work position, and the powder feeder must be activated. The powder, typically transported by a carrier gas like argon, reaches the deposition head almost immediately. However, to ensure a consistent flow, it is advisable to wait for 5 to 10 seconds. Additionally, the Tool Center Point (TCP) of the newly activated head must be aligned to the work TCP. These mechanical actions collectively take approximately 15 to 30 seconds, depending on the distances involved.

The time required for the changeover of the deposition head, although longer than the electronic switching, is a reasonable compromise given the complexity and precision required in the deposition process. The 15 to 30 seconds needed for this transition is a small fraction of the overall process time, especially when considering the benefits of being able to switch between different deposition methods on the fly. This capability is particularly advantageous in manufacturing environments where different materials or deposition techniques are required for different stages of production. By allowing for quick and efficient changeovers, the system enhances operational flexibility and reduces the need for manual intervention, thereby improving overall efficiency and throughput.

FIG. 5a is a schematic diagram that illustrates the two deposition heads placed inside a tool bay where a manual changeover is needed according to prior art. Another advantage which the proposed invention adds is the No tool change over time. Existing systems offer multiple deposition wire deposition head (3) and the powder deposition head (4); however, these inventions need human or robotic intervention to pick up the deposition head from a tool bay followed by manual adjustments/corrections to the TCP. This process often involves recalibrating the system to ensure precision, which can be time-consuming and prone to human error. Furthermore, the manual changeover process requires the machine to be temporarily halted, leading to downtime that affects overall productivity. Because of this manual changeover, the end-user loses both significant time and money, added with the requirement of a highly skilled workforce. The need for skilled operators increases operational costs and limits the scalability of the manufacturing process, as training new personnel can be both time-intensive and costly.

FIG. 5b is a schematic diagram that illustrates the two deposition heads placed inside a tool bay where both the two deposition heads are uniaxially mounted without changeover requirement according to embodiments as disclosed herein. The proposed invention solves this challenge by mounting both the deposition wire deposition head (3) and the powder deposition head (4) on the same axis, making both wire deposition head (3) and the powder deposition head (4) ready to be used any time required. This uniaxial configuration eliminates the need for manual intervention, thereby reducing the risk of misalignment and ensuring consistent deposition quality. Additionally, the machine has been configured in such a way that the machine identifies both the deposition wire deposition head (3) and the powder deposition head (4) as two different tools. The machine configuration remembers the TCP of the individual wire deposition head (3) and the powder deposition head (4), and as soon as the operator feeds a digital signal in terms of M-Code (Machine Codes) to the machine, the desired deposition head turns active and comes down to its working position, making it ready to use in practically no time. The proposed invention is also configured in such a way that as soon as the operator calls for a particular deposition head, the other deposition head automatically goes back to its home position. This feature of the proposed invention adds a lot of safety to the operation by avoiding any collision with the existing 3D-printed layers. The automatic retraction of the inactive head minimizes the risk of accidental damage to the printed structure, thereby preserving the integrity of the final product and reducing material waste.

FIG. 6a is a schematic diagram that illustrates a single laser fiber used to connect multiple deposition heads according to prior art. The traditional approach, as depicted in FIG. 6a, involves a single laser fiber being utilized to connect multiple deposition heads, which include a wire deposition head and a powder deposition head. This setup, while functional, presents several challenges. The primary issue is the need for manual changeover of the optical fiber when switching between deposition heads. Optical fibers (18 or 19) are not only delicate but also costly, necessitating careful handling during the changeover process. This operation requires the expertise of an optical specialist and must be conducted in a clean room environment to prevent contamination or damage to the fibers. Consequently, this requirement significantly increases the time and resources needed for changeover, thereby reducing the overall efficiency of the system.

FIG. 6b is a schematic diagram that illustrates the two deposition heads mounted on the same axis, and independent laser fibers (18, 19) are ready to use without any changeover time according to embodiments as disclosed herein. The innovative approach illustrated in FIG. 6b addresses these limitations by employing two independent laser fibers, each permanently connected to one of the deposition heads. This configuration eliminates the need for manual fiber changeover, as both the wire deposition head and the powder deposition head are simultaneously connected to the laser source. The inclusion of a beam switch enhances this setup by allowing the laser beam to be directed to either deposition head as needed. The beam switch is a sophisticated device that can rapidly redirect the laser beam between different output ports, enabling seamless transitions between tasks without the downtime associated with manual fiber swapping.

This advancement in laser fiber connectivity and beam switching technology offers significant benefits for industrial applications. By maintaining a constant connection between the laser source and the deposition heads, the system can perform tasks such as cutting, welding, and additive manufacturing more efficiently. The programmable nature of the beam switch allows for precise control over the laser path, ensuring that the laser power is optimally utilized for each specific task. This not only improves the speed and flexibility of the manufacturing process but also reduces the wear and tear on the equipment, as there is less physical handling of the optical fibers. Overall, this innovation represents a significant leap forward in laser system design, enhancing both operational efficiency and reliability.

The proposed invention offers a transformative approach to additive manufacturing, bringing forth a suite of advantages that significantly enhance the production landscape. One of the standout benefits is the enhanced manufacturing flexibility it provides. The dual deposition system, which allows for both simultaneous and sequential deposition of powder and wire, introduces a new level of versatility in the creation of complex parts. This capability is particularly beneficial for industries that require components with varied material properties, such as aerospace and automotive sectors. By enabling the integration of different materials within a single part, manufacturers can tailor the properties of each section to meet specific performance requirements, thus expanding the scope of design possibilities and innovation.

Further, the proposed invention facilitates improved production efficiency, a critical factor in today's fast-paced manufacturing environment. The system's ability to rapidly switch between high-resolution powder deposition and high-speed wire deposition drastically reduces production time. This flexibility means that manufacturers can optimize their production schedules, swiftly adapting to changing demands without compromising on quality. Additionally, the integration of both deposition methods within a single system minimizes downtime associated with machine setup and adjustments. This streamlined process not only accelerates production cycles but also enhances overall operational efficiency, allowing businesses to meet tight deadlines and increase throughput.

Cost savings are another significant advantage offered by this technology. The precise control over material usage afforded by the dual deposition system leads to substantial material efficiency, reducing waste and lowering material costs. This precision is particularly advantageous in industries where material costs constitute a significant portion of production expenses. Furthermore, the reduction in the number of machines and setups required translates to lower operational and maintenance costs. By consolidating multiple manufacturing processes into a single system, businesses can achieve economies of scale, further enhancing their profitability.

The foregoing description of the specific implementations will so fully reveal the general nature of the implementations herein that others can, by applying current knowledge, readily modify and/or adapt for various applications without departing from the generic concept, and, therefore, such modifications and adaptations should and are intended to be comprehended within the meaning and range of equivalents of the disclosed implementations. It is to be understood that the phraseology or terminology employed herein is for the purpose of description and not of limitation. Therefore, while the implementations herein have been described in terms of preferred implementations, those skilled in the art will recognize that the implementations herein can be practiced with modification within the scope of the implementations as described herein.

1. An additive manufacturing system with powder and wire capabilities for metal 3D printing of a material, comprising:
a dual-head configuration assembly including a wire deposition head to deposit the material at a workspace in a wire feedstock form and a powder deposition head to deposit the material in a powder feedstock form, wherein the wire deposition head and the powder deposition head are mounted on a common axis and move together;
a carriage connected to both the wire deposition head and the powder deposition head, wherein the carriage is configured to move along a hollow rectangular channel, thereby moving both the wire deposition head and the powder deposition head from left to right direction or vice versa;
vertical rails for each of the wire deposition head and the powder deposition head, wherein the vertical rails allows the wire deposition head and the powder deposition head to travel up and down directions independently to avoid obstruction during deposition;
an laser source assembly connected to the wire deposition head and the powder deposition head, wherein the laser source assembly generates an input laser beam to move one of the wire deposition head and the powder deposition head and automatically switch between the wire deposition head and the powder deposition head for printing the deposited material in the wire feedstock form and the powder feedstock form.

2. The additive manufacturing system as claimed in claim 1, wherein the wire deposition head and the powder deposition head independently move in a vertically upward direction and a vertically downward direction to avoid obstruction of a tool path when the wire deposition head is activated.

3. The additive manufacturing system as claimed in claim 1, wherein the laser source assembly comprises:
a laser generator to produce the input laser beam;
a first optical fiber connecting the laser generator to the wire deposition head, wherein first optical fiber is used for deposition of the material in the wire feedstock form and the second optical fiber based on the input laser beam received from the laser generator;
a second optical fiber connecting the laser generator to the powder deposition head, the second optical fiber is used for deposition of the material in the powder feedstock form based on the input laser beam received from the laser generator; and
an beam switch connected to the laser generator, wherein the beam switch is electrically controlled and being capable of receiving the input laser beam and distributing the input laser beam into four output beams;
a programmable logic controller (PLC) operatively connected to the beam switch, wherein the PLC being located within an electrical cabinet and configured to control the operation of the beam switch; and
an operator interface configured to send control signals to the PLC, wherein the control signals including M-Code instructions for selecting one of the four output beams.

4. The additive manufacturing system as claimed in claim 3, wherein the beam switch is responsive to the control signals from the PLC to selectively direct the input laser beam to the first optical fiber and the second optical fiber.

5. The additive manufacturing system as claimed in claim 3, wherein the control signals are provided based on at least one of a deposition rate of the material that is melted and deposited onto a substrate per unit of time, a feature size and an available feedstock.

6. The additive manufacturing system as claimed in claim 3, wherein switching of the input laser beam is programmable for redirecting the input laser beam between the first optical fiber and the second optical fiber in a predefined time period.

7. The additive manufacturing system as claimed in claim 1, wherein the hollow rectangular channel is equipped with linear guiding rails and driving motors on both front and back sides, allowing traversal the heads around the workspace.

8. The additive manufacturing system as claimed in claim 1, wherein the wire deposition head is mounted on a front side of the additive manufacturing system while the powder deposition head is mounted on a back side of the additive manufacturing system for ease of an operator to change wire or cut the wire without any hassle while an argon chamber is closed.

9. The additive manufacturing system as claimed in claim 8, wherein the powder deposition head is configured to rotate independently to accommodate complex geometries or surfaces that are not perpendicular to the powder deposition head.

10. The additive manufacturing system as claimed in claim 8, wherein the argon chamber surrounds the wire deposition head and the powder deposition head, maintaining an inert atmosphere to prevent oxidation of reactive materials during a printing process.

11. The additive manufacturing system as claimed in claim 1, comprising limit switches integrated with the carriage to prevent the powder deposition head and the wire deposition head from exceeding safe operational limits.

12. The additive manufacturing system as claimed in claim 1, comprising a wire straightener positioned on a left side of the wire deposition head for wire feed from a spool.

13. The additive manufacturing system as claimed in claim 1, comprising two color pyrometers connected to the wire deposition head and the powder deposition head, wherein both the two color pyrometers captures time-temperature data to control melt pool temperature by adjusting the input laser beam, and wherein the two color pyrometers are capable of independent rotation for cladding on vertical or tilted surfaces to maintain perpendicularity to a deposition surface.

14. The additive manufacturing system as claimed in claim 1, comprising servo drives for positioning the wire deposition head and the powder deposition head at a known or defined position.

15. The additive manufacturing system as claimed in claim 1, comprising rails connected to the vertical rails to allows the wire deposition head and the powder deposition head to travel front and back direction.

16. The additive manufacturing system as claimed in claim 1, comprising pneumatic system to take the wire deposition head and the powder deposition head up and down direction.

17. The additive manufacturing system as claimed in claim 1, comprising guide rails connected to the powder deposition head for independent movement of the powder deposition head.

18. The additive manufacturing system as claimed in claim 1, comprising water cooling line split connected to the powder deposition head to manage the thermal conditions of the powder deposition head during an additive manufacturing process.
